(19) United States
(12) Patent Application Publication
(10) Pub. No.: US 2010/0258498 A1
(43) Pub. Date: Oct. 14, 2010

(54) Filter Drinking Straw

(76) Inventor: Douglas Finelli, Las Vegas, NV (US)

Correspondence Address: Talbott & Talbott, 30765 Pacific Coast Highway, Suite 324, Malibu, CA, 90265, US

(21) Appl. No.: 12/420,398

(22) Filed: Apr. 8, 2009

(51) Int. Cl. A47G 21/18; B01D 29/25

(52) U.S. Cl. 210/473; 239/33

(57) ABSTRACT

The invention discloses a drinking straw, that in one embodiment, seals one end of the straw and includes a plurality of openings along the structure of the straw to allow liquids to easily enter the straw while at the same time filtering out any non-dissolved particles, seeds or ice from entering the straw and then being subsequently ingested by the user.

### BACKGROUND

The public today has available to it a large selection of drinks to chose from in order to ingest at home, on the run, or in a restaurant or bar. Many of the available drinks are very thick, making them hard to drink using a drinking straw currently found on the market, or they may contain ice, seeds, pulp, unwanted physical contaminants or other non-dissolved items that should not, or may not, want to be ingested by the user.

The present invention relates to an inexpensive drinking straw that solves the problems of filtering drinks through the use of a filter element. The present invention can also be used to increase the open area that is available to the liquid in a drinking straw in order to reduce the effort needed by a user to ingest the liquid.

Numerous drinking fluid purification devices are known in the art for the filtering of biological or toxic dissolved materials in an attempt to make the fluid purified for drinking but these are not relevant to the present invention. U.S. Pat. Nos. 6,811,036 B1, 5,518,613 and 4,995,96.

Based upon the foregoing, there is a need for a device that can accomplish the filtering of drinks, in a simple and economic manner, in order to prevent the ingestion of any non-dissolved contaminants or other undesired physical elements contained in a drink without the use of complicated filtering materials that may be used for the removal of biological or toxic contaminants.

### SUMMARY

The object of the present invention is to provide an inexpensive device for the filtering of non-dissolved contaminates in a liquid from being ingested by the user of the straw. The present invention is unique in its field.

### BRIEF DESCRIPTION OF THE DRAWINGS

FIG. 1 is a side view of an embodiment with an end of the straw sealed in a pointed end with filter openings.

FIG. 2 is an end view of the embodiment of the invention from the sealed end showing a cross-section of the filter openings.

FIG. 3 is a side view of the embodiment of the invention with an alternative embodiment of a capped end.

FIG. 4 is an end view of the embodiment of the invention from the sealed end.

FIGS. 5, 6, 7,8 and 9 show an embodiment of the invention with a filter end.

FIGS. 10 and 11 show an embodiment of the invention where the filter openings are slotted.

FIGS. 12, 13, 14 and 15 show an embodiment of the invention where the end of the straw is sealed with a single opening and filter element.

### DESCRIPTION

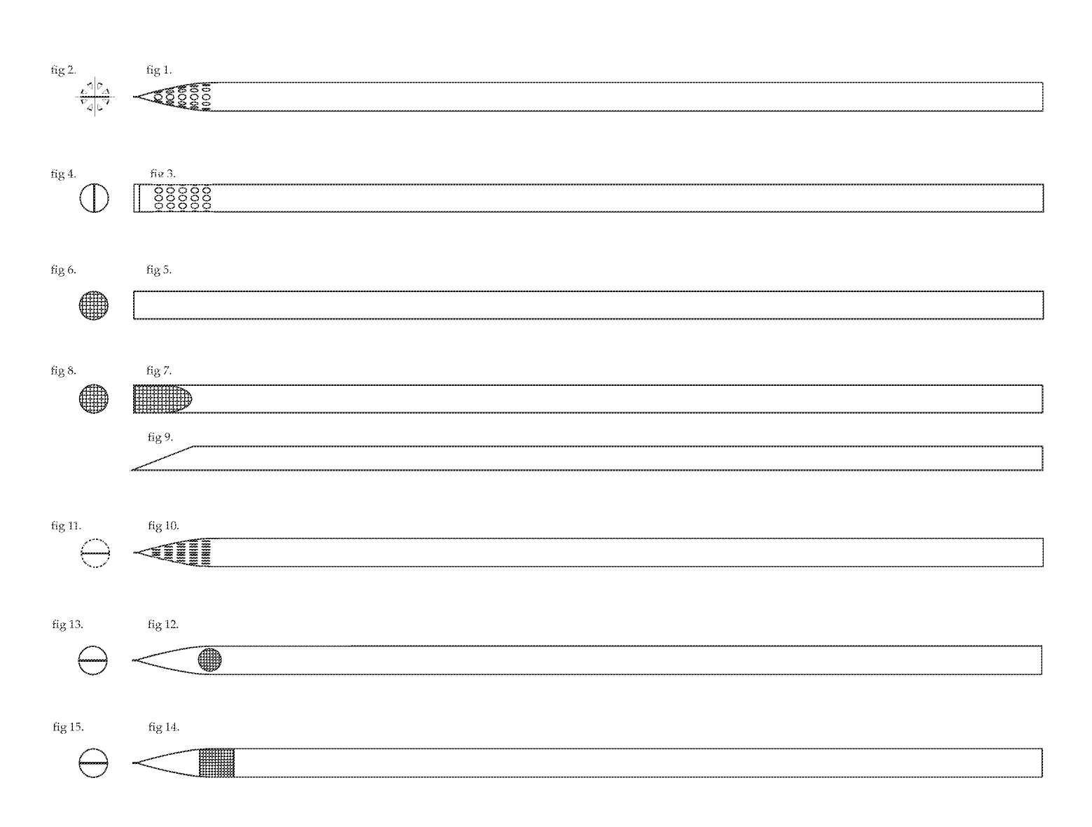

The following discussion describes in detail one embodiment of the invention and several other possible embodiments. As shown in FIG. 1 the embodiment shown has a closed pointed end, thereby allowing the straw to be easily inserted in a drink that may be thick or contain objects, such as ice or seeds. A plurality of openings, as shown in FIGS. 1 and 2, are placed on the wall of the straw wall, thereby creating an opening for the flow of fluids while at the same time acting as a filter element to filter out and ice, seeds or other contaminants that may be in the fluid.

FIGS. 3 and 4 show an alternative embodiment of the invention showing a closed, but flat end of the straw along with the filtering openings.

FIGS. 12, 13, 14 and 15 show a further embodiment of the closed end straw that consists of a single opening with a filter element over the single opening.

In another embodiment of the invention, both ends of the drinking straw are open, as shown in FIGS. 5, 6, 7 8 and 9, and one end is covered by a filter element. This embodiment may also include a plurality of openings between the ends of the straw or a single opening covered by a filter element.

In the above mentioned embodiments the number and size of the openings can be adjusted for the size of the objects to be filtered and for the viscosity of the drink to allow for easier drinking as shown in FIGS. 10 and 11.

Although the preferred embodiments of the invention have been disclosed for illustrative purposes, those skilled in the art will appreciate the various modifications, additions, and substitutions are possible, without departing from the scope and sprit of the invention as disclosed in the accompanying claims

What is claimed is:

1. A drinking straw comprising:
a straw having a closed end, and
a plurality of openings between the ends of the straw.

2. A drinking straw comprising:
a straw having a closed end, and
a single opening between the ends of the straw, and
a filter element covering the single opening.

3. A drinking straw comprising:
a straw having two open ends, and
one end of the straw has a filter element.

4. The straw according to claim 3, wherein:
The straw includes a plurality of openings between the ends of the straw.

5. The straw according to claim 3, wherein:
the straw includes a single opening between the ends of the straw, and
a filter element covering the single opening.
